(19) United States
(12) Patent Application Publication
(10) Pub. No.: US 2019/0281028 A1
(43) Pub. Date: Sep. 12, 2019

(54) SYSTEM AND METHOD FOR DECENTRALIZED AUTHENTICATION USING A DISTRIBUTED TRANSACTION-BASED STATE MACHINE

(71) Applicants: Michael Thomas Gillan, Burlington (CA); Ketan Kumar Kapadia, Ajax (CA)

(72) Inventors: Michael Thomas Gillan, Burlington (CA); Ketan Kumar Kapadia, Ajax (CA)

(21) Appl. No.: 16/294,119

(22) Filed: Mar. 6, 2019

Related U.S. Application Data
(60) Provisional application No. 62/639,232, filed on Mar. 6, 2018.

(51) Int. Cl. H04L 29/06; H04L 9/32

(52) U.S. Cl. CPC H04L 63/0442; H04L 9/3247; H04L 9/3271; H04L 63/0861

(57) ABSTRACT

A system and method for authenticating access in a decentralized manner to a secure resource over a communication network using a distributed transaction-based state machine is disclosed. The system and method provided rely on an attestation contract executed by the distributed transaction-based state machine to attest to identity of a user attempting access to a secure resource rather than the traditional approach of relying on a pre-shared key stored at the secure resource. Identity authentication is delegated to the distributed transaction-based state machine and the result is observed by the secure resource to determine whether to grant access.

### FIELD

The present disclosure relates generally to a system and method for obtaining authenticated access to a secure resource over a communication network. More particularly, the disclosure relates to using a distributed transaction-based state machine operating on a blockchain to provide authentication to the secure resource.

### BACKGROUND

Passwords have long been used to restrict access to computer systems. Password security was introduced to computing in the Compatible Time Sharing System and Unics (Unix) systems that were developed at the Massachusetts Institute of Technology and Bell Laboratories in the 1960s. Passwords are still commonly used to restrict access to personal computing devices, such as laptops and mobile phones, and to access remote computing services of all kinds across private and public networks.

For as long as we have been using passwords to restrict access to computer systems, they have been one of the simplest and most commonly exploited vulnerabilities to computer system security. According to the Verizon's Data Breach Investigations Report published in 2018, 93% of breaches were related to hacking and within the hacking category 81% of the attacks involved leveraging weak, stolen or default passwords stolen credentials, i.e. username and passwords. There is no arguing that passwords are becoming less and less reliable in protecting data and identities. Their management, protection, and memorization are becoming increasingly problematic, and malicious actors have countless ways to steal them, break them, reset them, or get past them.

Passwords can be vulnerable for a number of reasons. One of those reasons is that users often select weak passwords. The dilemma is that good passwords can be too complex to remember which favors users selecting passwords that are easy to remember or using the same passwords for multiple purposes. Users often select popular passwords that can be hacked with a dictionary attack, but strong passwords can also be susceptible to more advanced password cracking tools.

Passwords can also be compromised by phishing schemes where a scammer will trick someone into sharing information or passwords. These attacks are usually delivered through e-mails or text messages that provide a link to a website that mimics a trusted website and requests that the user enter their credentials. Scammers can create professional and authentic looking e-mails and websites that are difficult to differentiate from the real thing.

Malware is another vector that can be used to compromise passwords. A scammer can send an e-mail or other message that includes a surreptitious link to download the malware. Upon execution, the malware can harvest passwords and other credentials through access to the file system or using a key logger.

Multi-factor authentication mechanisms provide one solution to the vulnerability of passwords, but due to the complexity of their implementation, they have failed to gain traction with business-to-consumer applications. Two-factor authentication methods typically rely on ‘something known’ as well as ‘something owned’ to provide increased security over a password alone, but the setup process can be cumbersome and requires some technical knowledge on the part of the user. Even multi-factor authentication solutions are hackable with tools such as Evilgnix. Passwords continue to remain the principle method of authentication because of their simplicity and straightforwardness.

Biometric information (e.g. fingerprint, iris, face, voice) can be used as a password substitute. This information is based on unique and immutable characteristics of the user rather than the user's knowledge. For this reason, it is more difficult to be faked or stolen. Access using biometric information also carries its own issues, risks and vulnerabilities. If biometric information is ever compromised this is not something that the user can change as simply as they can a password. It can also be difficult to present biometric information to access remote systems. U.S. Patent Application No. 20160344730A1 describes a solution that enables a user to access web-based resources on a first device by authenticating themselves on a second device, such as their smart phone, by using the means of authentication that exist on the second device, including biometric information.

Blockchain technology has also been applied to attempt to address some of the vulnerabilities associated with passwords. The characteristics of blockchain technology can provide several advantages. The technology relies on strong encryption using private-public key encryption so that a user must have access to their private key to initiate transactions. Blockchain also provides an immutable public ledger that is distributed and agreed upon by all parties on the network which can provide an audit trail when used for access to a system. The consensus mechanism of blockchain technology also makes it difficult to hack. The distributed nature of blockchain technology also ensures that there is not a single point of failure to the system.

U.S. Patent Publication No. 20170250972A1 to Ronda et al. describes a system for distributed identity verification that uses blockchain technology. Ronda et al. describes a user device obtaining access to a website through the user device authenticating the user at the user device using a password, biometric token, or other factor, and then generating a distributed service ledger entry. The distributed service ledger ensures the entry is properly signed and was pre-registered to write the ledger entry prior to creating an attribute release entry which the remote server can observe on the distributed service ledger entry.

U.S. Patent Publication No. 20160162897A1 to Feeney describes a system and method for user authentication using crypto-currency transactions as access tokens. Feeney relies on a user initiating a crypto-currency transaction to demonstrate possession of a private key that is associated with the user's public key. U.S. Patent Publication No. 20170310653A1 to Zhang describes a system that provides identity verification on a similar principle. Zhang describes initiating a random transaction between accounts in a blockchain-based system and providing a verification code to the server requesting identity verification. The verification code is based on an intelligent contract operating on the blockchain-based system and the server obtains the associated block to verify the verification code to authenticate the user.

Blockchain and smart contract technology can also provide a distributed transaction-based state machine where every node in the network is running its own independent implementation of a virtual machine. Each implementation on each node follows strictly specified state change rules that enforces agreement in a transparent and autonomous manner. This allows algorithms to be created and deployed on the blockchain network that are executed in a distributed fashion across all nodes in the network, and guarantees that the outcome of the execution of the algorithm will be identical for all nodes. The instructions and state data for these algorithms are stored in the blockchain, a distributed ledger which is understood to be indelible and transparent. The use of a distributed ledger for storage coupled with a distributed transaction state-machine for execution removes trust from the system and allows transactions to be processed with absolute confidence in the outcome. The Ethereum Virtual Machine, or EVM, is one example of such a distributed transaction-based state machine that operates on the Ethereum blockchain network.

It is also understood that such a distributed transaction-based state machine can provide the ability to create and store immutable computer programs that execute instructions deterministically in the context of the distributed virtual machine. These distributed computer programs are generally referred to as “smart contracts”.

It is also understood that such a distributed transaction-based state machine can provide a mechanism for verification of digital signatures. A digital signature is a mathematical scheme for presenting the authenticity of digital messages or documents, typically using a private-public key pair. A valid digital signature gives a recipient reason to believe that the message was created by a known sender (authentication), that the sender cannot deny having sent the message (non-repudiation), and that the message was not altered in transit (integrity). Digital signatures and private-public key architectures provide an advantage over password-based authentication because there is no pre-shared key (i.e. the password) that both parties must maintain and can be vulnerable to attack.

There is a need for authentication methods that do not rely solely on the authorizing party retaining a pre-shared key for each user. The characteristics of distributed transaction-based state machines and digital signatures can provide advantages over authentication methods that rely on using pre-shared keys.

### SUMMARY

According to a first aspect, a method is provided for authenticating an access request to a secure resource using a distributed transaction-based state machine. The method comprises receiving an authentication challenge at a computing device from the secure resource in response to the access request; providing a prompt on a display of the computing device requesting consent; digitally signing an authentication response message with a private key stored at the computing device after receiving consent; and transmitting the signed authentication response message to an attestation contract stored and executing on the distributed transaction-based state machine, the attestation contract having a public key associated with the private key and the attestation contract verifying that the signed authentication response message was signed with the private key to provide an attested authentication response message, wherein the attested authentication response message is observed by the secure resource to determine whether to grant the access request.

In some aspects, the method can further comprise obtaining consent by obtaining authentication locally on the computing device. Obtaining authentication locally on the computing device can use biometric information or a personal identification number (PIN) entry, for example. The access request can be generated by a first computing device and the method steps can be are carried out by a second computing device. The access request can be for access to account data stored at the secure resource. The account data can associate authorized computing devices and an address for the attestation contract on the distributed transaction-based state machine.

In some aspects, the method can further comprise first generating the private key and the public key associated with the private key, and generating the attestation contract to include the public key and a method of verifying the authentication response message is digitally signed with the private key, and deploying the attestation contract to the distributed transaction-based state machine. In some aspects, generating the attestation contract can further comprise providing a method of adding or removing public keys associated with one or more computing devices authorized to access the secure resource.

In some aspects, the attested authentication response message can be stored on a distributed ledger of a blockchain. The attested authentication response message can be observed by the secure resource by either querying the attestation contract or observing the attested authentication message stored on the distributed ledger.

The distributed transaction-based state machine can be a state machine operating on a blockchain network. The distributed transaction-based state machine has multiple nodes and execution results of the attestation contract are reached by consensus amongst the nodes. The state machine can be the Ethereum Virtual Machine operating on the Ethereum blockchain network.

In other aspects, a system for authenticating an access request to a secure resource using a distributed transaction-based state machine is provided. The system comprises a processor, a display, and a memory storing instructions, the instructions being executable by the processor to: receive an authentication challenge from the secure resource in response to the access request; provide a prompt on the display requesting consent; digitally sign an authentication response message with a private key stored in the memory after receiving consent; and transmit the signed authentication response message to an attestation contract stored and executing on the distributed transaction-based state machine, the attestation contract having a public key associated with the private key and the attestation contract verifying that the signed authentication response message was signed with the private key to provide an attested authentication response message, wherein the attested authentication response message is observed by the secure resource to determine whether to grant the access request.

The system can further comprise an input device, and the memory can further comprise instructions to obtain consent by obtaining authentication by the input device. The input device can obtain biometric information, a personal identification number (PIN) entry, or any other information for attesting to the identity of the user locally on the computing device. In other aspects, the memory can further comprise instructions to first generate the private key and the public key associated with the private key; and generate the attestation contract to include the public key and a method of verifying the authentication response message is digitally signed with the private key; and deploy the attestation contract to the distributed transaction-based state machine.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a block diagram of a system for providing decentralized identity attestation to a secure resource through the use of a distributed transaction-based state machine;

FIG. 2 is a block diagram of an example architecture of a computing device for implementing decentralized identity attestation;

FIG. 3 is a flowchart diagram of a method for registering a user's computing device with a distributed transaction-based state machine to provide decentralized identity attestation; and

FIG. 4 is a flowchart diagram of a method for attesting to identity by a computing device with a secure resource through an attestation contract executing on distributed transaction-based state machine.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

The embodiments of the systems, devices and methods described herein may be implemented in hardware or software, or a combination of both. Some of the embodiments described herein may be implemented in computer programs executing on programmable computers, each computer comprising at least one processor, a computer memory (including volatile and non-volatile memory), at least one input device, and at least one output device. For example, and without limitation, the programmable computers may be a server class computer having multiple processors and at least one network interface card. Program code may operate on input data to perform the functions described herein and generate output data.

Distributed computing paradigms are referenced herein with respect to the use of blockchain technology and distributed transaction-based state machines. It will be understood by those of ordinary skill in the art how the teachings herein can be applied to blockchain technology using smart contracts operating on a distributed virtual machine. For example, and without limitation, the Ethereum blockchain and virtual machine may be used to implement the distributed transaction-based state machine embodiments described herein.

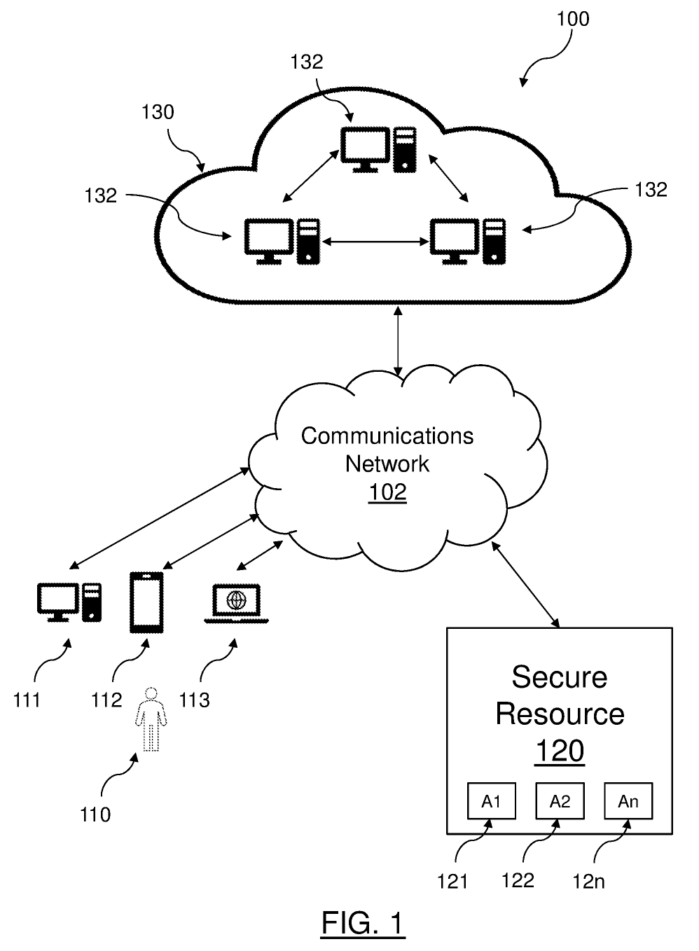

Reference is first made to FIG. 1 which illustrates a system 100 for providing decentralized identity attestation of a user 110 to a secure resource 120 using a distributed transaction-based state machine 130. The decentralized identity attestation process is initiated by user 110 attempting to gain access to secure resource 120 over communication network 102 using any one of computing devices 111-113. User 110 can use a first computing device 111, such as a desktop or laptop computer, to request access to secure resource 120, which can be a web application or web site operating on communication network 102. For example, secure resource 120 can be an online bank's server, an e-mail server, or other secured website that restricts access to private data and is operating on a public communication network 102, such as the internet, remote from user's first computing device 111. A second computing device 112, such as a mobile computing device or smart phone, can be used to consent to an authentication challenge as is described below.

Typically, secure resource 120 is a server-grade computing device operating within a data center. Secure resource 120 can accept requests from multiple users that are attempting to obtain access to their associated account data, illustrated as A1 121, A2 122 through An 12n. For example, user 110 can have an account at secure resource 120 to access account data A1 121 associated with user 110. Account data 121-12n can include information about the relationship between users and secure resource 120. When secure resource 120 receives a request for access, secure resource 120 must first authenticate user 110 to confirm their identity and ensure that they are authorized to access to account data 121.

Traditionally, authentication of the user is confirmed by checking that a pre-shared key (e.g. a password) provided by user 110 matches what is stored at secure resource 120 and associated with user's account data 121. In the system 100 of FIG. 1, identity authentication is delegated to distributed transaction-based state machine 130 and the result can be observed by secure resource 120. In some embodiments, traditional authentication using a pre-shared key can be used in addition to the methods described herein.

When user 110 requests access to secure resource 120 from first computing device 111, an authentication challenge is sent from secure resource 120 to any one or more of computing devices 111-113 associated with user's account A1 121. The authentication challenge is received by one or more computing devices 111-113 and routed to an authentication logic module executing on the device. The authentication logic module presents a prompt on the display of computing devices 111-113 for user 110 to provide consent to access account data 121 at secure resource 120. If user 110 is attempting to obtain access using computing device 111, then the authentication challenge can be sent to a second computing device 112-113 that is associated with user's account A1 121 at secure resource 120 rather than the first computing device 111.

The authentication challenge can include information. Such information can include, but is not limited, to: a client identifier used by secure resource 120, an account name (e.g. name of account data A1 121), a summary of the request for display to the user, and a nonce. Further detailed information about the request for access can also be included in the authentication challenge, such as the specific page, account, access channel, etc.) for display to the user or for providing an audit trail of the access attempts.

Preferably, rather than supply a password at the second computing device 112, user 110 is required to authenticate via the strongest authentication method provided by their computing device as part of providing consent. For example, this can include using facial recognition, fingerprint scan, or personal identification number entry. The authentication on the computing device acts as the authentication service provider rather than requiring verifying a pre-shared key at the secure resource 120.

User 110 is prompted to allow or deny the request to access secure resource 120. The authentication logic module executing on any one of computing devices 111-113 creates an authentication response message, either allowing or denying the request, and digitally signs the authentication response message with a private key that is generated during the registration process, as described below.

The authentication logic module then transmits the digitally signed authentication response message to an attestation contract that is stored and executing on distributed transaction-based state machine 130. The attestation contract was created during registration of user 110 with secure resource 120 by a registration module operating on any one of computing devices 111-113. The attestation contract can have a mechanism to verify whether an authentication response message is properly signed in accordance with private keys stored on any one of computing devices 111-113. The attestation contract stores the result of the verification operation which can be queried by secure resource 120 in order to determine whether to permit access.

Distributed transaction-based state machine 130 is a state machine operating on a blockchain network. The blockchain network comprises a number of nodes 132 coupled by communication network 102 where each node 132 executes program code of the attestation contract. The results of the verification operation of the attestation contract are reached by consensus and enforced autonomously across the network of nodes. The results of verification are stored in the distributed ledger of the blockchain to provide an immutable and transparent audit trail of verification results of the attestation contract. In some embodiments, distributed transaction-based state machine 130 can be implemented using the Ethereum Virtual Machine operating on the Ethereum blockchain network.

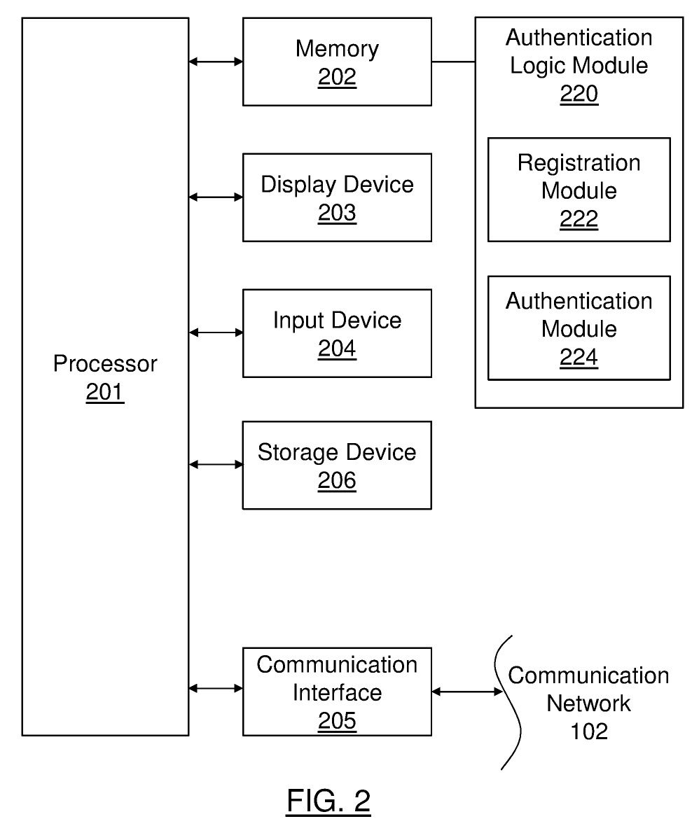

Reference is next made to FIG. 2 which illustrates an example architecture of computing devices and servers for implementing system 100 for providing authentication of user 110 to secure resource 120. Nodes 132 of distributed transaction-based state machine 130 can also share a similar architecture. Computing devices 111-113 and secure resource server 120 can include a processor 201, memory 202 (which can include read-only memory as well as random access memory), display device 203, input mechanism 204, and communication interface 205 for communication over communication network 102. Processor 201 is configured with software and other logic to perform one or more processes, steps and other functions described herein. Processor 201 may process information and instructions stored in memory 202, such as provided by a random access memory (RAM) or other dynamic storage device, for storing information and instructions which are executable by processor 201. Memory 202 also may be used for storing temporary variables or other intermediate information during execution of instructions to be executed by processor 201. Memory 202 may also include the ROM or other static storage device for storing static information and instructions for processor 201. A storage device 206, such as a flash memory, a magnetic disk or other long-term storage technology, may be provided for storing information and instructions. Communication interface 205 enables computing devices 111-113 or secure resource server 120 to communicate with one or more communication networks 102 (e.g., cellular network) through use of a network link (wireless or wired). Using the network link, computing devices 111-113, secure resource 120 and nodes 132 of distributed transaction-based state machine 130 can communicate with one another as described herein. Input mechanism 204 can be a keyboard, touch sensor (e.g. capacitive display), or other known input methods. Input mechanism 204 can further include means for capturing biometric information (e.g. fingerprint sensor, iris scanner, infrared facial scanning camera system, etc.).

Authentication logic module 220 of computing devices may include instructions stored in memory 202 and can include registration module 222 and authentication module 224. Processor 201 uses executable instructions stored in registration module 222 to establish private-public key pairs and create or alter the attestation contract stored on distributed transaction-based state machine 130 as described herein. Processor 201 uses executable instructions stored in authentication module 224 to receive and respond to authentication request messages, provide prompts for user on display device 203, and digitally sign authentication response messages with private keys, along with other aspects as are described herein. Authentication logic module 220 can be a software program operating on computing devices 111-113. For example, for mobile computing devices, such as smart phones or tablet computers, authentication logic module can be an iOS or Android application that is downloaded and executed on the device. Known methods for securely storing and using private keys by processor 201 and memory 202 should be used by authentication logic module 220.

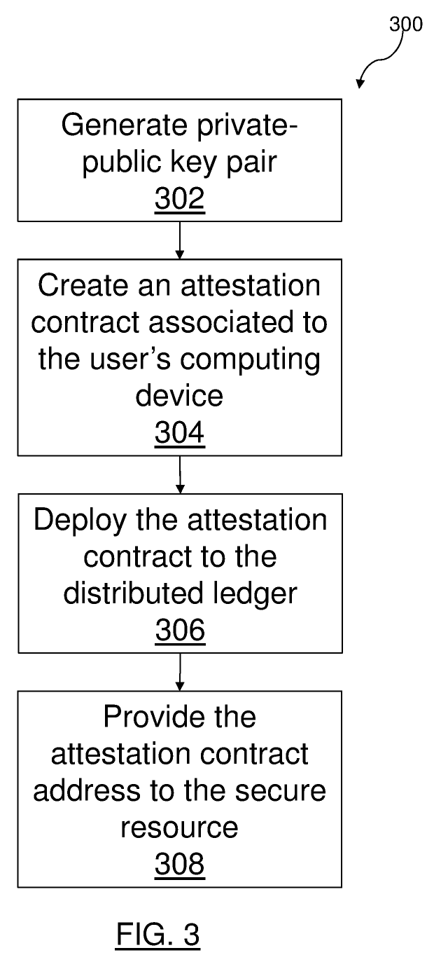

Reference is next made to FIG. 3, shown is a method 300 of registering any one of computing devices 111-113 with distributed transaction-based state machine 130 for providing decentralized identity attestation of user 110. In describing the example provided in FIG. 3, reference is made to the example embodiments of FIGS. 1-2 for the purposes of illustrating suitable components or elements for performing a step being described.

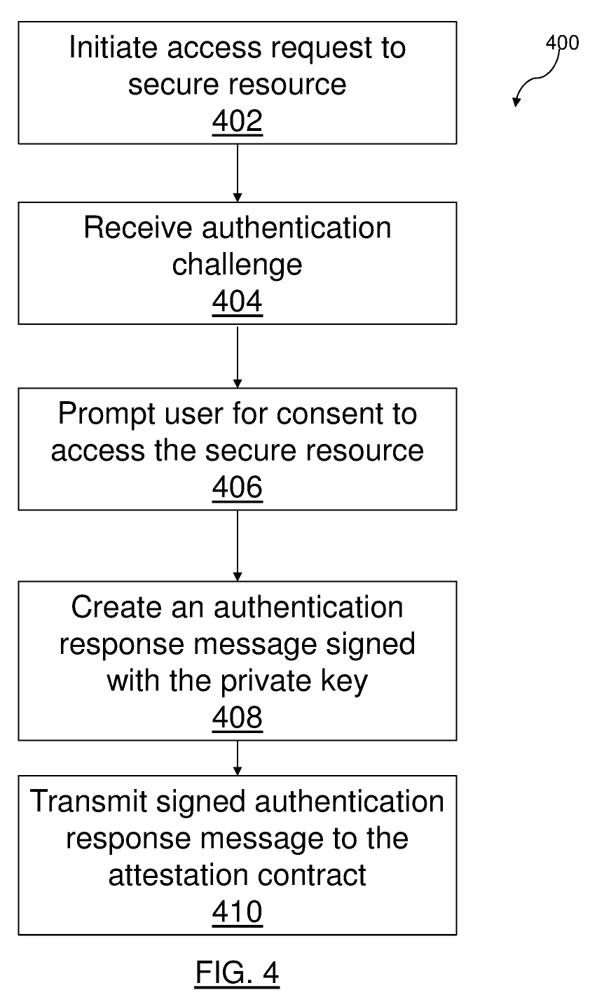

Registration method steps can be executed by a registration module 222 of authentication logic module 220 operating on a computing device 111-113 having a processor 201 and memory 202. These steps are performed to configure a computing device 111-113 and an attestation contract operating on distributed transaction-based state machine 130 to allow for the authentication method provided in FIG. 4, as described below. These steps can be initiated by the user when they choose to enroll for enhanced authentication with secure resource 130.

Registration method 300 can be executed on a second computing device 112, such as a mobile computing device owned by user 110, that may be different than the device typically used by user 110 to access secure resource 120. Registration method 300 begins at step 302, a private-public key pair is generated on the computing device 111-113 to be registered. The private key will be stored by computing device 111-113 and used to digitally sign messages as is described below. In some embodiments, step 302 can be comprised of creating a new address on the blockchain ledger where the attestation contract will be deployed.

Next at step 304, an attestation contract is created that is associated with the account data A1 121 of user 110. The attestation contract is a distributed computer program, or smart contract, that will execute on the distributed transaction-based state machine 130. The attestation contract provides an algorithm or method to verify whether an authentication response message has been correctly signed with the appropriate private key using known cryptographic methods. This involves the attestation contract having access to the public key generated from the private-public key pair created in step 302. Preferably, the public key is stored on the distributed ledger, either as a block address or hard-coded into the logic of the attestation contract, so that it is immutable and not vulnerable to attack.

The attestation contract can be capable of storing (or be associated with) multiple public keys that can each correspond to one of the computing devices 111-113 that are owned by the user 110. This allows a user to approve an authentication request from more than one computing device. In some embodiments, the attestation contract can require approval from more than one computing device. The attestation contract can have a mechanism for adding or removing public keys associated with computing devices 111-113. Preferably, adding public keys associated to the attestation contract requires the approval from one or more computing devices that are already associated with the attestation contract. This may require a computing device 111-113 to digitally sign a message requesting addition of another public key to the attestation contract to add a new computing device to the attestation contract.

An attestation contract can be created and associated for each account A1-An 121-12n that user may have at secure resource 120 (i.e. one attestation contract per account per secure resource). In other embodiments, the attestation contract can be more generally used for validating authentication requests from one or more secure resources 120 (i.e. one attestation contract per user).

Next, as step 306 the attestation contract is deployed to the distributed ledger of distributed transaction-based state machine 130. The attestation contract shall be stored in the immutable storage of the distributed ledger of the blockchain. In some embodiments, the distributed transaction-based state machine 130 may require that the attestation contract is funded to allow for deployment of the attestation contract. This may require the user 110 or secure resource 120 to provide the user's account on the blockchain (e.g. the block address created in step 302) with sufficient funding, such as blockchain currency, for example, to allow for the attestation contract to be executed. For example, in the Ethereum blockchain, the user 110 or secure resource 120 would ensure that there is enough Ether in the user's block address associated with the attestation contract to allow the methods to be executed by the computing resources of distributed transaction-based state machine 130.

After the attestation contract has been deployed to distributed transaction-based state machine 130, the attestation contract must be linked to the user's account data A1 121 at secure resource 120. The address of the attestation contract can be provided to the secure resource 120, which can then associate the attestation contract address with the user 110 in its user database (i.e. account data A1 121) to be used during the authentication process. In some embodiments, this association between the attestation contract and the user can be stored in the blockchain so that this association is immutable and not an avenue for attacking the user's account data A1 121 with secure resource 120.

It is important that the attestation contract address is communicated securely and stored securely. Preferably, registration method 300 is performed upon establishing an account at secure resource 120.

Secure resource 120 can provide configuration information as part of registration method 300. This information can include a client identifier to represent secure resource 120, the account identifier associated with the account data (i.e. account data A1-An 121-12n), and a web address uniform resource locator (URL) that the registration module 222 and authentication module 224 can use to communicate securely with secure resource 120, such as for communicating the attestation contract address, for example. This configuration information can be provided by way of URL, e-mail, or a quick-response (QR) code that can be captured by a camera of a mobile computing device, which can then be used by registration module 222 in implementing method 300.

Reference is next made to FIG. 4, shown is a method 400 of attesting to identity of a user by a computing device 111-113 with a secure resource 120 through an attestation contract executing on distributed transaction-based state machine 130. In describing the example provided in FIG. 4, reference is made to the example embodiments of FIGS. 1-2 for the purposes of illustrating suitable components or elements for performing a step being described. Method 400 can be executed by an authentication module 224 of authentication logic module 220 operating on a computing device 111-113 having a processor 201 and memory 202.

First at step 402, a user attempts to access secure resource 120 using a first one of computing devices 111-113. Typically, this is a user attempting to access a remote secure resource 120 served over communications network 102, such as the internet, using a web browser or a specific application executing on the first computing device. For example, a user 110 can user their home computer, such as a laptop or desktop computer, to access their online bank account or e-mail server through a web browser on their home computer.

Secure resource 120, upon receipt of user's request to access their account data A1 121, will create an authentication challenge, which can include information such as details regarding secure resource 120, account data A1 121 of which access is requested, hardware identification information of device making access request, for example. If a user has not registered for identity attestation using distributed transaction-based state machine 130, then the user may be routed to registration method 300. Secure resource 120 then transmits the authentication challenge to one or more of user's computing devices 111-113, which is received in step 404. The specific computing devices are registered to the user's account data A1 121 in registration method 300. In some embodiments, the user may select a preferred computing device (if there are more than one registered at secure resource 120) to receive the authentication challenge. Preferably, user 110 can receive the authentication challenge on their mobile device (e.g. a smart phone running the Android or iOS operating systems) to be processed by authentication module 224. It may also be preferable that the computing device that the user receives the authentication challenge is different from the computing device that the user used to first attempt access to secure resource 120 (e.g. a user attempting access with their home computer would receive the authentication challenge on their mobile computing device that is registered in method 300).

Next, at step 406, upon receipt of the authentication challenge, the computing device will prompt the user 110 to consent to access of account data A1 121 at secure resource 120. In some embodiments, authentication logic module 220 can be an iOS or Android application running on the user's mobile computing device that generates a prompt on the display indicating that an authentication request has been made, including the name and/or type of secure resource 120 that has been requested. The user can then make an informed decision about whether they truly requested authenticated access to that specific secure resource 120. In some embodiments, the authentication challenge can require that consent further includes authentication locally on computing device, for example, by using biometric information (e.g. facial recognition, a fingerprint scan) or a personal identification number (PIN) entry as supported by their computing device, and then can provide their yes or no response to the authentication request.

Next, at step 408, computing device proceeds to create an authentication response message that includes the consent information. The authentication response message is then digitally signed with a private cryptographic key. The consent information can include whether the request was allowed or denied, along with information contained in the authentication challenge described above, and information about how the user authenticated on the device (e.g. by fingerprint or PIN) and the timestamp of when the user authenticated locally on the computing device, for example. The private key generated in registration method 300 and stored on the associated computing device is used to digitally sign an authentication response message in accordance with known private-public key cryptographic methods. The digitally signed authentication response message is then transmitted to the attestation contract associated with the user in step 410.

The attestation contract will verify whether the received authentication response message was properly signed by verifying the digital signature. Verification by the attestation contract verifies that the sending computing device is compared with the authorized computing devices registered with the attestation contract. The attestation contract can further include a method to store the message and any additional data about the authentication attempt (e.g. time stamps, channel authentication was sought, etc.) or the authentication response message (e.g. time stamps, hardware identifiers, etc.). This data is stored in the distributed ledger provided by the blockchain and can serve as an audit trail of authentication attempts and grants. The attestation contract can provide a method for storing and querying these attested authentication response messages. Secure resource 120 can observe this verification result by periodically polling the attestation contract to determine whether to grant access to the secure resource 120 and the requested account data A1 121. In other embodiments, the attestation contract can provide a means to send a message to secure resource upon receiving a verified authentication response message.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A method for authenticating an access request to a secure resource using a distributed transaction-based state machine, the method comprising:
receiving an authentication challenge at a computing device from the secure resource in response to the access request;
providing a prompt on a display of the computing device requesting consent;
digitally signing an authentication response message with a private key stored at the computing device after receiving consent; and
transmitting the signed authentication response message to an attestation contract stored and executing on the distributed transaction-based state machine, the attestation contract having a public key associated with the private key and the attestation contract verifying that the signed authentication response message was signed with the private key to provide an attested authentication response message, wherein the attested authentication response message is observed by the secure resource to determine whether to grant the access request.

2. The method of claim 1, further comprising obtaining consent by obtaining authentication locally on the computing device.

3. The method of claim 2, wherein obtaining authentication locally on the computing device uses any one of biometric information or a personal identification number (PIN) entry.

4. The method of claim 3, wherein the access request is generated by a first computing device and the method steps of claim 2 are carried out by a second computing device.

5. The method of claim 1, wherein the access request is for account data stored at the secure resource, the account data associates authorized computing devices and an address for the attestation contract on the distributed transaction-based state machine.

6. The method of claim 1 further comprising first generating the private key and the public key associated with the private key; and generating the attestation contract to include the public key and a method of verifying the authentication response message is digitally signed with the private key; and deploying the attestation contract to the distributed transaction-based state machine.

7. The method of claim 6, wherein generating the attestation contract further comprises providing a method of adding or removing public keys associated with one or more computing devices authorized to access the secure resource.

8. The method of claim 1, wherein the attested authentication response message is stored on a distributed ledger of a blockchain.

9. The method of claim 8, wherein the attested authentication response message is observed by the secure resource by any one of querying the attestation contract and observing the attested authentication message stored on the distributed ledger.

10. The method of claim 1, wherein the distributed transaction-based state machine is a state machine operating on a blockchain network.

11. The method of claim 10, wherein the distributed transaction-based state machine has multiple nodes and execution results of the attestation contract are reached by consensus amongst the nodes.

12. The method of claim 11, wherein the state machine is the Ethereum Virtual Machine operating on the Ethereum blockchain network.

13. A system for authenticating an access request to a secure resource using a distributed transaction-based state machine, the system comprising:
a processor;
a display; and
a memory storing instructions, the instructions being executable by the processor to:
receive an authentication challenge from the secure resource in response to the access request;
provide a prompt on the display requesting consent;
digitally sign an authentication response message with a private key stored in the memory after receiving consent; and
transmit the signed authentication response message to an attestation contract stored and executing on the distributed transaction-based state machine, the attestation contract having a public key associated with the private key and the attestation contract verifying that the signed authentication response message was signed with the private key to provide an attested authentication response message, wherein the attested authentication response message is observed by the secure resource to determine whether to grant the access request.

14. The system of claim 13, wherein the system further comprises an input device, and the memory further comprises instructions to obtain consent by obtaining authentication by the input device.

15. The system of claim 14, wherein the input device obtains any one of biometric information or a personal identification number (PIN) entry.

16. The system of claim 13, wherein the memory further comprises instructions to first generate the private key and the public key associated with the private key; and generate the attestation contract to include the public key and a method of verifying the authentication response message is digitally signed with the private key; and deploy the attestation contract to the distributed transaction-based state machine.
